(19) United States
(12) Patent Application Publication
(10) Pub. No.: US 2024/0153117 A1
(43) Pub. Date: May 9, 2024

(54) METHOD AND SYSTEM FOR DETERMINING A DEPTH IMAGE OF A SCENE

(71) Applicant: STMicroelectronics (Grenoble 2) SAS, Grenoble (FR)

(72) Inventors: Jeremie Teyssier, Grenoble (FR); Cedric Tubert, Saint-Egreve (FR); Thibault Augey, Grenoble (FR); Valentin Rebiere, Grenoble (FR); Thomas Bouchet, Fontanil-Cornillon (FR)

(21) Appl. No.: 18/488,086

(22) Filed: Oct. 17, 2023

(30) Foreign Application Priority Data
Oct. 27, 2022 (FR) 2211205

(51) Int. Cl. G06T 7/521; G06T 7/90

(52) U.S. Cl. CPC G06T 7/521; G06T 7/90; G06T 2207/10024; G06T 2207/10028

(57) ABSTRACT

The present description concerns a system for determining a depth image of a scene, configured to project a spot pattern onto the scene and acquire an image of the scene; determining I and Q values of the image pixels; determining, for each pixel, at least one confidence value to form a confidence image; determining the local maximum points of the confidence image having a confidence value greater than a first threshold; selecting, for each local maximum point, pixels around the local maximum point having a confidence value greater than a second threshold; determining a value Imoy equal to the average of the I values of the selected pixels and a value Qmoy equal to the average of the Q values of the selected pixels; and determining the depth of the local maximum point based on values Imoy and Qmoy.

### CROSS-REFERENCE TO RELATED APPLICATIONS

This application claims the benefit of French Application No. 2211205, filed on Oct. 27, 2022, which application is hereby incorporated by reference herein in its entirety.

### TECHNICAL FIELD

The present disclosure concerns the field of methods and systems for determining a depth image of a scene.

### BACKGROUND

Image acquisition systems capable of acquiring depth information have been provided. For example, indirect time of flight (iToF) detectors act to emit a light signal towards a scene, and then to detect the light signal reflected in return by objects of the scene. By estimating the phase shift between the emitted light signal and the reflected light signal, the distance of the scene with respect to the image acquisition system can be estimated.

It is desirable to have a system for acquiring a depth image by the indirect time of flight adapted to estimate the distance of the scene with respect to the image acquisition system with a high accuracy.

### SUMMARY

There is a need to overcome all or part of the disadvantages of known systems for acquiring a depth image by indirect time of flight.

An embodiment provides a method of determining a depth image of a scene, including the following steps: a) projecting a spot pattern onto the scene and acquiring an image of the scene, each pixel of the image being obtained from electric charges accumulated during collection phases; b) determining the I and Q values of the image pixels; c) determining, for each pixel of the image, at least one confidence value which is a function of at least part of the accumulated charges, to form a confidence image or confidence images; d) determining the local maximum points of the confidence image or of one of the confidence images having a confidence value, of the same confidence image or of another one of the confidence images, greater than a first threshold; e) selecting, for each local maximum point determined at step d), pixels around the local maximum point having a confidence value, of the confidence image used to determine the local maximum points or of another one of the confidence images, greater than a second threshold; f) determining, for each local maximum point determined at step d), a value Imoy equal to the average of the I values of the selected pixels and a value Qmoy equal to the average of the Q values of the selected pixels; and g) determining, for each local maximum point, the depth of the local maximum point based on values Imoy and Qmoy.

An embodiment also provides a system for determining a depth image of a scene, the system being configured to: a) project a spot pattern onto the scene and acquire an image of the scene, each pixel of the image being obtained from electric charges accumulated during collection phases; b) determine the I and Q values of the image pixels; c) determine, for each pixel of the image, at least one confidence value which is a function of at least part of the accumulated charges, to form a confidence image or confidence images; d) determine the local maximum points of the confidence image having a confidence value, of the same confidence image or of another one of the confidence images, greater than a first threshold; e) select, for each local maximum point determined at step d), pixels around the local maximum point having a confidence value, of the confidence image used to determine the local maximum points or of another one of the confidence images, greater than a second threshold; f) determine, for each local maximum point determined at step d), a value Imoy equal to the average of the I values of the selected pixels and a value Qmoy equal to the average of the Q values of the selected pixels; and g) determine, for each local maximum point, the depth of the local maximum point based on values Imoy and Qmoy.

According to an embodiment, the first threshold is greater than the second threshold.

According to an embodiment, step d) includes the displacement of a first window on the confidence image and, for each position of the first window on the confidence image, the comparison of the value of a pixel of the confidence image located in the first window and which is not on the edge of the first window, with the values of the other pixels of the confidence image located in the first window.

According to an embodiment, step d) includes, in the case where the value of said pixel is greater than the values of the other pixels of the confidence image located in the first window, the comparison of the value of said pixel, of the same confidence image or of another one of the confidence images, with the first threshold.

According to an embodiment, step e) includes, for each local maximum point, the placing of a second window on the confidence image used to determine the local maximum points or on another one of the confidence images, the second window containing the local maximum point, and the comparison with the second threshold of the value of each pixel of the confidence image located in the second window, other than the local maximum point.

According to an embodiment, the second window is larger than the first window or equal to the first window.

According to an embodiment, the system includes a device for illuminating the scene with the spot pattern, and an image sensor for acquiring the image of the scene.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows an embodiment of a system for acquiring a depth image by indirect time of flight;

FIG. 2 schematically shows an embodiment of a system for acquiring a depth image by indirect time of flight implementing a light spot pattern;

FIG. 3 is a block diagram of an embodiment of a method of providing a depth map of a scene;

FIG. 4 is a graph illustrating an example of the light intensity of a light signal emitted and reflected according to an embodiment;

FIG. 5 is an example of a confidence image;

FIG. 6 is an example of a confidence image having the local maximum points indicated thereon;

FIG. 7 is an example of a selection mask;

FIG. 8 partially and schematically shows an embodiment of a processing module of the system of FIG. 1;

FIG. 9 is an image of a confidence map;

FIG. 10 is an example of a depth image; and

FIG. 11 is a block diagram of a computing device.

### DETAILED DESCRIPTION OF ILLUSTRATIVE EMBODIMENTS

Like features have been designated by like references in the various figures. In particular, the structural or functional features that are common among the various embodiments may have the same references and may dispose identical structural, dimensional and material properties.

For the sake of clarity, only the steps and elements that are useful for an understanding of the embodiments described herein have been illustrated and described in detail. In particular, usual electronic systems including an indirect time of flight sensor, called iToF imaging system hereafter, have not been detailed, the described embodiments being compatible with these usual systems.

In the following description, when reference is made to absolute position qualifiers, such as the terms “front,” “back,” “top,” “bottom,” “left-hand,” “right-hand,” etc., or to relative position qualifier, such as the terms “above,” “under,” “upper,” “lower,” etc., or to orientation qualifiers, such as the terms “horizontal,” “vertical,” etc., it is referred unless specified otherwise to the orientation of the drawings or an image in a normal position of observation.

Unless specified otherwise, the expressions “around,” “approximately,” “substantially,” and “in the order of” signify within 10%, and preferably within 5%.

The principle of indirect time of flight includes measuring a distance with respect to an object by measuring a phase lag between an emitted light wave and a light wave reflected by the object.

FIG. 1 schematically illustrates an embodiment of an iToF imaging system 1, which may be used to provide a measurement of the distance of a scene 2.

iToF imaging system 1 includes: an illumination device 4; a control module 6 of illumination device 4 configured to control illumination device 4 to actively illuminate scene 2 with an incident infrared light signal IL amplitude-modulated by a modulation signal ILM, the amplitude-modulated incident light signal IL being reflected by scene 2 into a reflected light signal RL; a lens 8 for collecting the reflected light signal RL forming an image of scene 2; an image sensor 10 with a pixel array configured to acquire the image of scene 2 and controlled by control module 6, each pixel of image sensor 10 being configured to supply an electric signal, called pixel value hereafter, representative of the reflected light signal RL captured by this pixel; and a module 12 for processing the images acquired by image sensor 10.

According to an embodiment, image sensor 10 may include an electronic circuit having the pixels formed therein and processing module 12 may also form part of this electronic circuit.

Generally, for an indirect time of flight (iToF) operation, processing module 12 correlates the reflected light signal RL with a demodulation signal to deliver a component value in-phase (“I value”) and a component value in quadrature (“Q value”) for each pixel, which are, respectively, called I and Q values. Based on the I and Q values for each pixel, processing module 12 determines a phase lag value φ, also called phase shift, for each pixel, which provides a phase image. Based on the phase image, processing module 12 can determine a depth value d for each pixel, which provides a depth image.

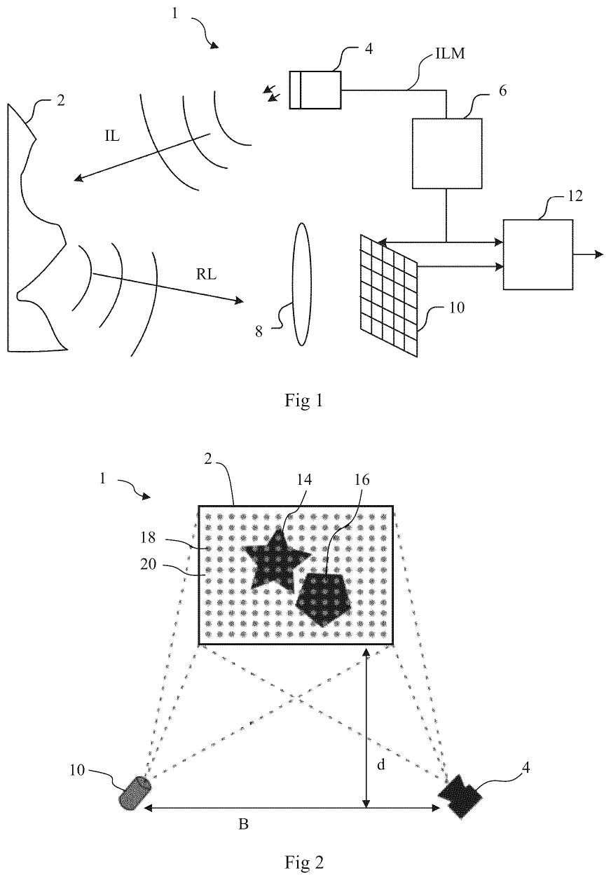

FIG. 2 schematically illustrates the principle of indirect time-of-flight distance measurement by structured-type illumination. Illumination device 4 is configured to illuminate scene 2 including objects 14 and 16, with a light spot pattern. The image sensor 10 acquires an image of the light spot pattern in scene 2. The pattern of light spots projected onto scene 2 by illumination device 4 results in a corresponding light spot pattern in the image acquired by the pixels of the image sensor 10.

The light spots appear in the image acquired by image sensor 10 in the form of a spatial light pattern including high-intensity areas 18 (the actual light spots) and low-intensity areas 20. The illumination device 4 and image sensor 10 are distant from each other by a distance B. This distance B is called baseline. Scene 2 exhibits a distance d with respect to baseline B. More precisely, each object 14, 16 or object point in scene 2 has an individual distance d to baseline B. The depth image of the scene provided by iToF imaging system 1 defines a depth value for each pixel of the depth image and thus provides depth information for scene 2 and objects 14, 16.

Typically, the pattern of light spots 14 projected onto scene 2 may result in a corresponding pattern of light spots captured on the pixels of image sensor 10. In other words, spot pixel regions may be present among the plurality of pixels of the acquired image and valley pixel regions may be present among the plurality of pixels of the acquired image. The spot pixel regions of the acquired image may include signal contributions originating from the light reflected by scene 2 but also originating from a background light, or a multipath interference. The valley pixel region of the acquired image may include signal contributions originating from a background light or a multipath interference.

For example, illumination device 4 may generate from 200 to 2,000 spots 18 on scene 2, for example, approximately 1,000 spots 18 on scene 2. The light spots may have the shape of a circle or a rectangle/square or any other regular or irregular shape. The light spot pattern may be a grid pattern or a line pattern or an irregular pattern. Preferably, illumination device 4 is configured so that each spot 18 has a maximum intensity at its center.

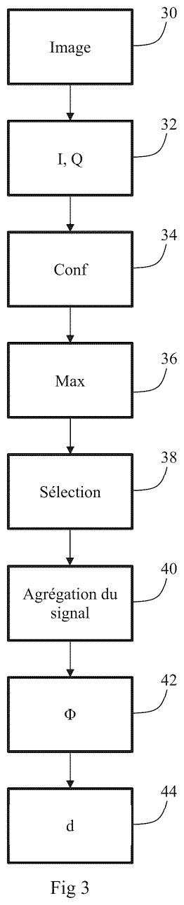

FIG. 3 is a block diagram of an embodiment of a method of determining a depth image implemented by the iToF imaging system.

At step 30 (Image), raw image data are received by image sensor 10.

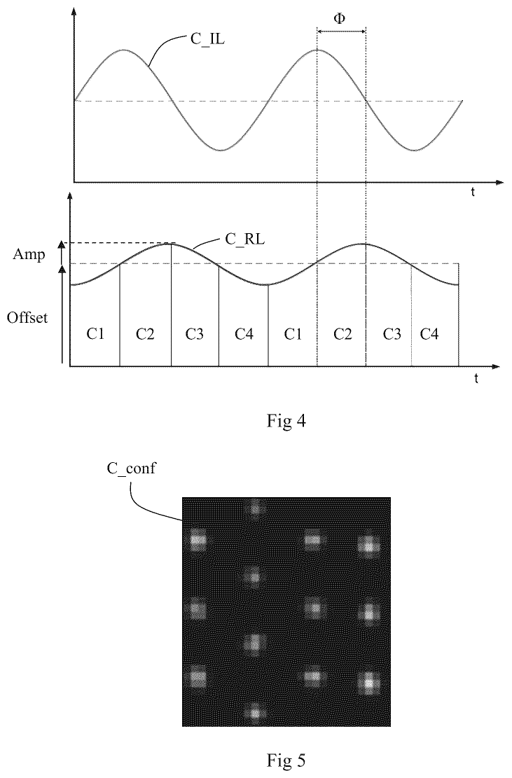

FIG. 4 is a graph showing, by a curve C_IL, an example of time variation of the light intensity of the incident amplitude-modulated light signal IL emitted by illumination device 4 towards scene 2, and, by a curve C_RL, an example of time variation of the light intensity of the reflected light signal RL received by one of the depth pixels of the image sensor 10. Although to simplify the comparison, these signals are shown in FIG. 4 as having substantially the same intensity, in practice the reflected light signal RL received by each depth pixel is likely to be notably less intense than the incident light signal IL.

In the example of FIG. 4, incident light signal IL is amplitude-modulated by a modulation signal ILM corresponding to a sine-wave signal of period T and frequency fmod. Each of the light intensity of the incident light signal IL and the light intensity of the reflected light signal RL thus has the shape of a sine wave of period T. However, in alternative embodiments, it may have a different periodic shape, for example, formed of a sum of sine waves, of triangular shape, or of square shape. As shown in FIG. 4, the received light signal RL has a non-zero average value Offset and a maximum amplitude Amp with respect to this average value.

Phase shift φ is for example estimated based on a sampling, for each pixel of image sensor 10, of the reflected light signal RL captured by the pixel during at least three distinct sampling windows, preferably during four distinct sampling windows, during each period T of the reflected light signal RL. For example, in FIG. 4, the acquisition of four samples per period has been illustrated.

The samples of each sampling window are for example integrated over a large number of periods, for example over approximately 100,000 periods, or more generally between 10,000 and 10 million periods. Each sampling window for example has a duration ranging up to one quarter of the period of the light signal. These sampling windows are called C1, C2, C3, and C4 in FIG. 4, and, in the example of FIG. 4, each sampling window is of the same duration and the four sampling windows have a total cycle time equal to the period of the light signal. More generally, there may or not be a time interval separating a sampling window from the next one and, in certain cases, there may be an overlapping between the sampling windows. Each sampling window for example has a duration in the range from 15% to 35% of the period of the light signal in the case of a pixel capturing four samples per period. Each sampling window for example has a duration in the range from 25% to 40% of the period of the light signal in the case of a pixel capturing three samples per period. The timing of sampling windows C1 to C4 is controlled to be synchronized with the timing of the incident light signal IL.

According to an embodiment, sampling window C1 is phase-shifted by 0° with respect to the modulation signal ILM. During sampling window C1, each pixel of image sensor 10 accumulates an electric charge Q1 which depends on the quantity of light received by the pixel during sampling window C1. Sampling window C2 is phase-shifted by 90° with respect to modulation signal ILM. During sampling window C2, each pixel of image sensor 10 accumulates an electric charge Q2 which depends on the quantity of light received by the pixel during sampling window C2. Sampling window C3 is phase-shifted by 180° with respect to modulation signal ILM. During sampling window C3, each pixel of the image sensor 10 accumulates an electric charge Q3 according to the quantity of light received by the pixel during sampling window C3. Sampling window C4 is phase-shifted by 270° with respect to modulation signal ILM. During sampling window C4, each pixel of image sensor 10 accumulates an electric charge Q4 which depends on the quantity of light received by the pixel during sampling window C4. The method carries on at step 32.

The determination of electric charges Q1, Q2, Q3, and Q4 may be performed according to another sampling method than that previously described. Another technique based on the detection of four samples per period is described in further detail in R. Lange and P. Seitz's publication entitled “Solid-state TOF range camera,” IEEE J. on Quantum Electronics, vol. 37, No. 3, March 2001, which is incorporated herein by reference as authorized by law.

At step 32 (I, Q), the I and Q values are determined for each pixel based on the raw image data supplied by the image sensor 10.

According to an embodiment, the component in quadrature Q is provided by the following relation:

Q=Q3−Q4. [Math 1]

According to an embodiment, the component in phase I is provided by the following relation:

I=Q1−Q2. [Math 2]

The method carries on at step 34.

At step 34 (Conf), a confidence map, also called a confidence image, is determined. According to an embodiment, a confidence value (Conf) is determined for each pixel based on the I and Q values of the pixel. Generally, confidence value conf is a function both of the I value and the Q value of the pixel.

FIG. 5 is an example of a confidence map C_conf obtained at step 34.

According to an embodiment, confidence value (Conf) corresponds to the amplitude (AmpL1) according to standard L1 of the reflected light signal RL and provided by the following relation:

Conf=AmpL1=\sqrt{I²+Q²}. [Math 3]

According to another embodiment, confidence value (Conf) corresponds to the amplitude (AmpL2) according to standard L2 of the reflected light signal RL and provided by the following relation:

Conf=AmpL2=|I|+|Q|. [Math 4]

According to another embodiment, confidence value (Conf) corresponds to a function of amplitude (Amp), corresponding to AmpL1 or AmpL2, and of the value Offset of the pixel, and is, for example, equal to the square of the signal-to-noise ratio (SNR), for example, according to the following relation:

$$Conf = {SNR}^{2} = \frac{{AMP}^{2}}{Offset} , \qquad [ Math 5 ]$$

where value Offset is for example provided by the following relation in the case of four samplings per period:

Offset=Q1+Q2+Q3+Q4. [Math 6]

As an example, in the case where the sampling is performed per half-period, the value Offset is equal to the sum of Q1 and Q3 and is also equal to the sum of Q2 and Q4.

According to another embodiment, the confidence value (Conf) corresponds to any other estimator of the signal-to-noise ratio (SNR) of the pixel.

The method carries on at step 36.

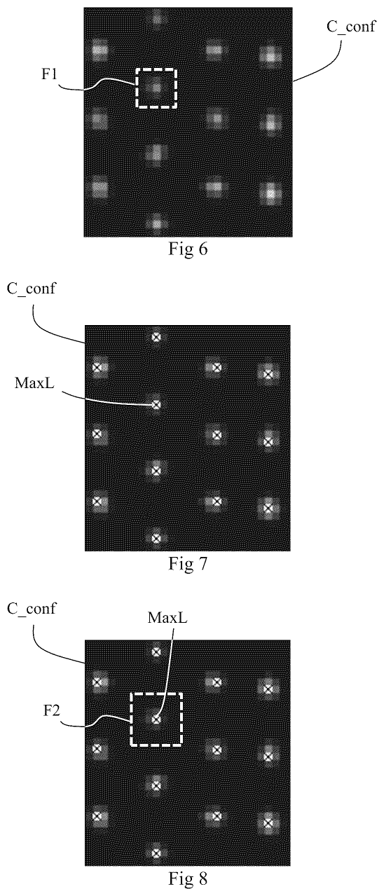

At step 36 (Max), a method of determining local maximum points of the confidence map is implemented and is illustrated by FIG. 6. According to an embodiment, the method includes sliding, on the confidence map, a first window F1, having its contour indicated in dotted lines in FIG. 6, on confidence map C_conf, and comparing the value of a pixel, called tested pixel, of the confidence map located in first window F1 and which is not on the edge of first window F1, with the values of the other pixels of the confidence map located in first window F1. According to an embodiment, the first window F1 corresponds to a group of adjacent pixels. According to an embodiment, the tested pixel is the pixel at the center of first window F1. According to an embodiment, first window F1 is a square window. Generally, the size of first window F1 depends on the distance between spots 18. According to an embodiment, the first window is a square window having a side length from 3 to 7 pixels, preferably of 5 pixels.

If the value of the tested pixel is not greater than all the values of the other pixels of first window F1, first window F1 is displaced to the next position. If the value of the tested pixel is greater than all the values of the other pixels of first window F1, and if the value of the tested pixel is greater than a first threshold, the tested pixel of the first window F1 is considered as a local maximum point of confidence map C_conf and the position of this local maximum point in confidence map C_conf is stored. First window F1 is displaced to the next position.

Step 36 is over when first window F1 has been displaced on confidence map C_conf to cover the entire confidence map C_conf. The method carries on at step 38.

FIG. 7 shows the confidence map C_conf of FIG. 5 on which each local maximum point MaxL obtained at step 36 is represented by a white pixel with a cross.

At step 38 (Selection), a method of selection of pixels of confidence map C_conf is implemented for each local maximum point MaxL determined at step 36 and is illustrated by FIG. 8. According to an embodiment, for each local maximum point MaxL, a step of selection of pixels of confidence map C_conf close to local maximum point MaxL is implemented. According to an embodiment, for each local maximum point MaxL, there is applied to the confidence map a second window F2, having its contour indicated in dotted lines in FIG. 8, containing local maximum point MaxL, where the local maximum is not on the edge of second window F2, and the value of each pixel of the confidence map location in second window F2, other than local maximum point MaxL, is compared with a second threshold. According to an embodiment, the first threshold and the second threshold are determined by trials. The second threshold is smaller than the first threshold. According to an embodiment, second window F2 corresponds to a group of adjacent pixels of the confidence map. According to an embodiment, second window F2 is larger than first window F1. According to an embodiment, second window F2 is centered on local maximum point MaxL. According to an embodiment, second window F2 is a square window. Generally, as for the first window F1, the size of second window F2 depends on the distance between spots 18. According to an embodiment, the first window is a square window having a side length from 1 to 31 pixels, preferably from 5 to 9 pixels, more preferably of 7 pixels. For each local maximum point MaxL, the pixel assembly including local maximum point MaxL and the pixels of second window F2 which are selected at step 38 form a confidence area. The positions of the pixels of each confidence area are stored. The method carries on at step 40.

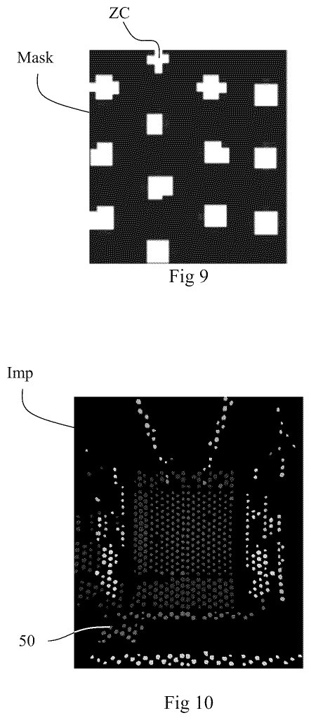

FIG. 9 shows an image Mask of same dimension as the confidence map of FIG. 5 and on which each confidence area ZC determined at step 38 is represented by white pixels, the other pixels of the image being black.

In the previously described embodiment, the same confidence map is used at step 36 for the comparison with the first threshold, at step 36 for the determination of the local maximum points, and at step 38 for the comparison with the second threshold. According to another embodiment, different confidence maps may be used at step 36 for the comparison with the first threshold, at step 36 for the determination of the local maximum points, or at step 38 for the comparison with the second threshold. Preferably, the same confidence map is used at step 36 for the comparison with the first threshold and at step 38 for the comparison with the second threshold. As an example, the confidence map obtained according to relation Math 3 may be used at step 36 for the comparison with the first threshold, the confidence map obtained according to relation Math 5 may be used at step 36 for the determination of the local maximum points, and the confidence map obtained according to relation Math 3 may be used at step 38 for the comparison with the second threshold.

At step 40 (Signal Aggregation), a correction of the I and Q values determined at step 32 is implemented. For each confidence area determined at step 38, processing module 12 determines the average Imoy of the I values of the pixels of the confidence area and determines the average Qmoy of the Q values of the confidence area. The method carries on at step 42.

At step 42 (φ), a phase lag φ is determined for each pixel of each confidence area based on values Imoy and Qmoy. According to an embodiment, the value of phase lag φ is provided by the following relation:

$$φ = arctan ( \frac{{Q}_{moy}}{{I}_{moy}} ) \qquad [ Math 8 ]$$

The method carries on at step 44.

At step 44 (d), a depth value d is determined for each confidence value based on the phase-lag value φ of the confidence area. According to an embodiment, the distance d to the object is provided by the following relation:

$$d = \frac{1}{2 \times π} \times \frac{c}{2 \times {f}_{mod}} \times φ , \qquad [ Math 9 ]$$

where c is the speed of light.

The distance d determined for each pixel provides the depth image containing spots 50, the color of each spot 50 depending on the depth d determined at step 44 for the considered spot.

FIG. 10 is an example of a depth image Imp.

In previously-described embodiments, method steps may be carried out by using one or a plurality of computing devices. The embodiments are thus not limited to an operation with a specific type of computing device.

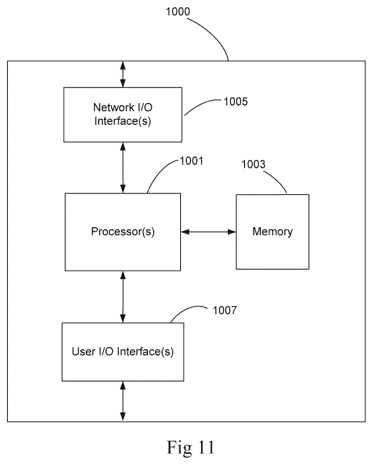

FIG. 11 is a block diagram of a computing device 1000 that may be used to form processing module 12 or control module 6. Computing device 1000 may include one or a plurality of processors 1001 (Processor(s)) and one of a plurality of non-transitory computer-readable storage supports (for example, memory 1003 (Memory)). Memory 1003 may store, in non-transitory computer-readable storage means, computer program instructions which, when executed, implement the steps of the above-described detection method. Processor or processors 1001 may be coupled to memory 1003 and may execute these computer program instructions to cause the implementation of these steps.

Computing device 1000 may also include a network input/output interface 1005 (Network I/O Interface(s)) through which the computing device can communicate with other computing devices (for example, over a network), and may also include one or a plurality of user interfaces 1007 (User I/O Interface(s)) through which the computing device can supply an output signal to a user and receive an input signal from the user. The user interfaces may include peripherals such as a keyboard, a mouse, a microphone, a display peripheral (for example, a monitor or a touch screen), loudspeakers, a camera, or various other types of input/output peripherals.

The above-described embodiments may be implemented in several ways. As an example, the embodiments may be implemented by means of a dedicated circuit, of software, or of a combination thereof. When they are implemented by software, the software code may be executed on any suitable processor (for example, a microprocessor) or an assembly of processors, be they provided in a single computing device or distributed between a plurality of computing devices. It should be noted that any component or component assembly which carries out the previously described method steps can be considered as one or a plurality of controllers which control the above-described steps. The controller or the controllers may be implemented in many ways, for example, with a dedicated electronic circuit or with a general-purpose circuit (for example, one or a plurality of processors) which is programmed by means of software or of a microcode to execute the above-described method steps.

In this respect, it should be noted that an embodiment described herein includes at least one computer-readable storage medium (RAM, ROM, EEPROM, flash or another memory technology, CD-ROM, digital video disk (DVD) or another optical disk support, magnetic cassette, magnetic tape, magnetic storage disk or another magnetic storage device, or another non-transitory computer-readable storage support) coded with a computer program (that is, a plurality of executable instructions) which, when executed on a processor or a plurality of processors, carries out the steps of the above-described embodiments. The computer-readable medium may be portable so that the program stored thereon can be loaded on any computing device to implement aspects of the techniques described herein. Further, it should be noted that the reference to a computer program which, when it is executed, performs one of the above-described steps of the method, is not limited to an application program running on a host computer. Conversely, the terms computer program and software are here used in a general meaning to refer to any type of computer code (for example, application software, microware, a microcode, or any other form of computer instruction) that may be used to program one or a plurality of processors to implement aspects of the previously-described methods.

Various embodiments and variants have been described. Those skilled in the art will understand that certain features of these various embodiments and variants may be combined, and other variants will occur to those skilled in the art. Finally, the practical implementation of the described embodiments and variations is within the abilities of those skilled in the art based on the functional indications given hereabove.

What is claimed is:

1. A method, comprising:
acquiring an image in response to projecting a spot pattern onto a scene, each pixel of the image obtained from electric charges accumulated during collection phases;
determining an in-phase component value and a quadrature component value for each pixel;
determining a confidence value for each pixel as a function of the electric charges;
forming a confidence map based on the confidence values;
determining a plurality of local maximum points for the confidence map, the determining comprising determining a pixel within a first window for each local maximum point with the greatest value and with a value greater than a first threshold;
selecting, for each local maximum point, one or more pixels within a second window having a value greater than a second threshold, wherein the second window includes the local maximum point, and wherein each local maximum point and the one or more pixels form a respective confidence area;
determining, for each confidence area of the image, an average in-phase component value and an average quadrature component value; and
determining, for each local maximum point, a corresponding depth based on the average in-phase component value and the average quadrature component value.

2. The method of claim 1, wherein the first threshold is greater than the second threshold.

3. The method of claim 1, wherein each local maximum point in the first window is not located on an edge of the first window.

4. The method of claim 1, wherein the second window is larger or equal to the first window.

5. The method of claim 1, wherein the method is based on indirect time of flight (iToF) principles.

6. The method of claim 1, further comprising determining a color for each spot pattern based on the corresponding depth determined for each local maximum point.

7. The method of claim 1, wherein the confidence value is determined based on an amplitude value of the pixel or the amplitude value of the pixel and an offset value for the pixel.

8. A device, comprising:
a non-transitory memory storage comprising instructions; and
a processor in communication with the non-transitory memory storage, the processor configured to execute instructions to:
acquire an image in response to projecting a spot pattern onto a scene, each pixel of the image obtained from electric charges accumulated during collection phases;
determine an in-phase component value and a quadrature component value for each pixel;
determine a confidence value for each pixel as a function of the electric charges;
form a confidence map based on the confidence values;
determine a plurality of local maximum points for the confidence map, the determining comprising determining a pixel within a first window for each local maximum point with the greatest value and with a value greater than a first threshold;
select, for each local maximum point, one or more pixels within a second window having a value greater than a second threshold, wherein the second window includes the local maximum point, and wherein each local maximum point and the one or more pixels form a respective confidence area;
determine, for each confidence area of the image, an average in-phase component value and an average quadrature component value; and
determine, for each local maximum point, a corresponding depth based on the average in-phase component value and the average quadrature component value.

9. The device of claim 8, wherein the first threshold is greater than the second threshold.

10. The device of claim 8, wherein each local maximum point in the first window is not located on an edge of the first window.

11. The device of claim 8, wherein the second window is larger or equal to the first window.

12. The device of claim 8, wherein the device comprises an image sensor configured to acquire the image.

13. The device of claim 8, wherein device operates under indirect time of flight (iToF) principles.

14. The device of claim 8, wherein the processor is configured to execute instructions to determine a color for each spot pattern based on the corresponding depth determined for each local maximum point.

15. A non-transitory computer-readable media storing computer instructions, that when executed by a processor, cause the processor to:
acquire an image in response to projecting a spot pattern onto a scene, each pixel of the image obtained from electric charges accumulated during collection phases;
determine an in-phase component value and a quadrature component value for each pixel;
determine a confidence value for each pixel as a function of the electric charges;
form a confidence map based on the confidence values;
determine a plurality of local maximum points for the confidence map, the determining comprising determining a pixel within a first window for each local maximum point with the greatest value and with a value greater than a first threshold;
select, for each local maximum point, one or more pixels within a second window having a value greater than a second threshold, wherein the second window includes the local maximum point, and wherein each local maximum point and the one or more pixels form a respective confidence area;
determine, for each confidence area of the image, an average in-phase component value and an average quadrature component value; and
determine, for each local maximum point, a corresponding depth based on the average in-phase component value and the average quadrature component value.

16. The non-transitory computer-readable media of claim 15, wherein the first threshold is greater than the second threshold.

17. The non-transitory computer-readable media of claim 15, wherein each local maximum point in the first window is not located on an edge of the first window.

18. The non-transitory computer-readable media of claim 15, wherein the second window is larger or equal to the first window.

19. The non-transitory computer-readable media of claim 15, wherein the corresponding depth is calculated as a function of phase lag, the phase lag calculated from the average in-phase component value and the average quadrature component value.

20. The non-transitory computer-readable media of claim 15, wherein the computer instructions, when executed by the processor, cause the processor to determine a color for each spot pattern based on the corresponding depth determined for each local maximum point.
